(19) United States
(12) Patent Application Publication
(10) Pub. No.: US 2013/0211957 A1
(43) Pub. Date: Aug. 15, 2013

(54) SYSTEMS AND METHODS OF MANAGING MARKETS

(71) Applicants: Elizabeth McVay Greene, Brooklyn, NY (US); Blue G. Thomas, New York, NY (US)

(72) Inventors: Elizabeth McVay Greene, Brooklyn, NY (US); Blue G. Thomas, New York, NY (US)

(21) Appl. No.: 13/763,727

(22) Filed: Feb. 10, 2013

Related U.S. Application Data
(60) Provisional application No. 61/597,484, filed on Feb. 10, 2012.

(51) Int. Cl. G06Q 30/06

(52) U.S. Cl. CPC G06Q 30/0633
USPC 705/26.8

(57) ABSTRACT

A process and system for managing markets is provided. The method includes receiving, by the computer, information descriptive of at least one product produced by at least one producer associated with at least one exchange. The method also includes receiving, by the computer, information descriptive of at least one order requested by at least one member associated with at least one destination, the at least one order including at least one identifier of the at least one product. The method further includes identifying, by the computer, at least one route including the at least one exchange and the at least one destination.

### RELATED APPLICATIONS

This application claims priority under 35 U.S.C. §119(e) to U.S. Provisional Application Ser. No. 61/597,484, entitled “SYSTEMS AND METHODS OF GOODS DISTRIBUTION,” filed on Feb. 10, 2012, which is hereby incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

Embodiments disclosed herein relate generally to managing markets and, more particularly, to systems and processes of managing markets that meet on a periodic basis.

2. Discussion

Farmers and both commercial and household consumers exhibit a growing interest in transacting directly. Between 2002 and 2007 (the last agricultural census data available), the number of farms involved in direct sales grew 17.21% to 136,817 while the value of products sold by these farms grew 49.13% to over $1.2 billion. Additionally, the USDA estimates that demand for locally sourced food will increase to $7 billion by 2012, suggesting demand exceeds the market's current capacity.

The direct market for agricultural products is constrained by time and place inefficiencies characterized by unpredictable and dispersed markets. The number of farmers' markets in the US increased 17% between 2010 and 2011, making farms' production more accessible to consumers but adding expense as farms reach fewer customers per market, pay more market entry fees, and hire more labor to work each physical market. Meanwhile, there have been over 1.8 million searches of the USDA's farmers' market guide since the beginning of 2011, and since 2004 Google searches for the terms “farmers market” and “local food” have increased 66% and 59%, respectively.

### SUMMARY

Some aspects disclosed herein connect producers of goods, such as farmers, with consumers interested in purchasing the goods through a centralized system, such as a web-based information portal. In some embodiments, the system provides improved profit potential and market reach, a way to sell products before products leave the farm, insight into customer preferences, and a distribution method that reduces costs. In addition, some embodiments provide customers a single point of contact with diverse products and a low-commitment, high-transparency channel to get products directly from producers.

In some embodiments, a market managing system includes memory, at least one processor coupled to the memory, a producer interface component executed by the at least one processor and configured to receive information descriptive of at least one product produced by at least one producer associated with at least one exchange, a member interface component executed by the at least one processor and configured to receive information descriptive of at least one order requested by at least one member associated with at least one destination, the at least one order including at least one identifier of the at least one product, and a routing engine component executed by the at least one processor and configured to identify at least one route including the at least one exchange and the at least one destination.

In some embodiments, the information descriptive of the at least one product includes an indication of whether the at least one product is available for sale. In some embodiments, the indication includes one or more identifiers of one or more exchanges through which the at least one product is available for sale. In some embodiments, the indication includes information descriptive of a confirmation date on which the at least one product is no longer available for sale through the at least one exchange. In some embodiments, the indication includes information descriptive of one or more exchange dates on which the at least one product will be delivered based on the description and routes of one or more exchanges. In some embodiments, the indication includes information descriptive of one or more delivery dates on which the at least one product will be delivered to the one or more destinations. In some embodiments, the information descriptive of the at least one order includes at least one identifier of the at least one producer, at least one identifier of the at least one destination, at least one identifier of the at least one product, and information descriptive of a method of payment.

In some embodiments, the system further includes an order processing engine component executed by the at least one processor on the confirmation date and configured to store an indication that the at least one product is no longer available for sale, aggregate one or more orders, and provide information descriptive of the one or more orders to the producer interface. The one or more orders include the at least one identifier of the at least one product, the at least one identifier of the at least one producer, and the at least one identifier of the at least one exchange.

In some embodiments, the system further includes a transporter interface component executed by the at least one processor and configured to receive information descriptive of the one or more orders, the information including a first quantity of the at least one product to be delivered to the at least one exchange on the exchange date and a second quantity of the at least one product to be delivered to the at least one destination, and provide the information descriptive of the one or more orders to an external entity.

Aspects of the disclosure also include a method implemented by a computer system, the method including receiving, by the computer, information descriptive of at least one product produced by at least one producer associated with at least one exchange, receiving, by the computer, information descriptive of at least one order requested by at least one member associated with at least one destination, the at least one order including at least one identifier of the at least one product, and identifying, by the computer, at least one route including the at least one exchange and the at least one destination. Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a context diagram of a periodic market system;

FIG. 2 is a schematic diagram of the market management system illustrated in FIG. 1;

FIG. 3 is a schematic diagram of one example of a computer system that may perform processes and functions disclosed herein;

FIG. 4 is an illustration of a screen provided by a member interface component;

FIG. 5 is an illustration of a screen provided by a producer interface component; and

FIG. 6 is an illustration of a flow diagram illustrating a process of managing markets.

### DETAILED DESCRIPTION

Some of the aspects and embodiments disclosed herein describe new apparatus and processes of managing markets. For instance, according to some embodiments, a computer system executes components that enable producers of products, such as farmers, to offer products for sale. Producers can also indicate exchange locations to which the producer can provide products. Members, such as household or commercial consumers, can request products from the producers. The products available to each member can depend on the destinations or drop-offs to which the member has subscribed (or have otherwise been indicated as relevant to the member's ability to purchase) and the products provided to the destinations or drop-offs by the producers. The system thus allows producers and members to participate in a dynamic exchange of products.

In some embodiments, the members can also indicate destination or drop-off locations at which the members are willing to receive products. Destinations include general locations on a route where products are conveyed from transporter to one or more types of specific locations, including, but not limited to, sorts and drop-offs. Examples of destinations include locations like existing market stands, restaurants, homes, offices, community centers, apartment complexes, sort centers, or other spots in neighborhoods where members receive their orders at a specified time and place. Sorts include locations where orders are sorted before further distribution toward drop-offs or other “last mile” methods such as home delivery. Drop-offs are destinations that are specific, addressable locations where order items can be received by members.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Periodic Market System

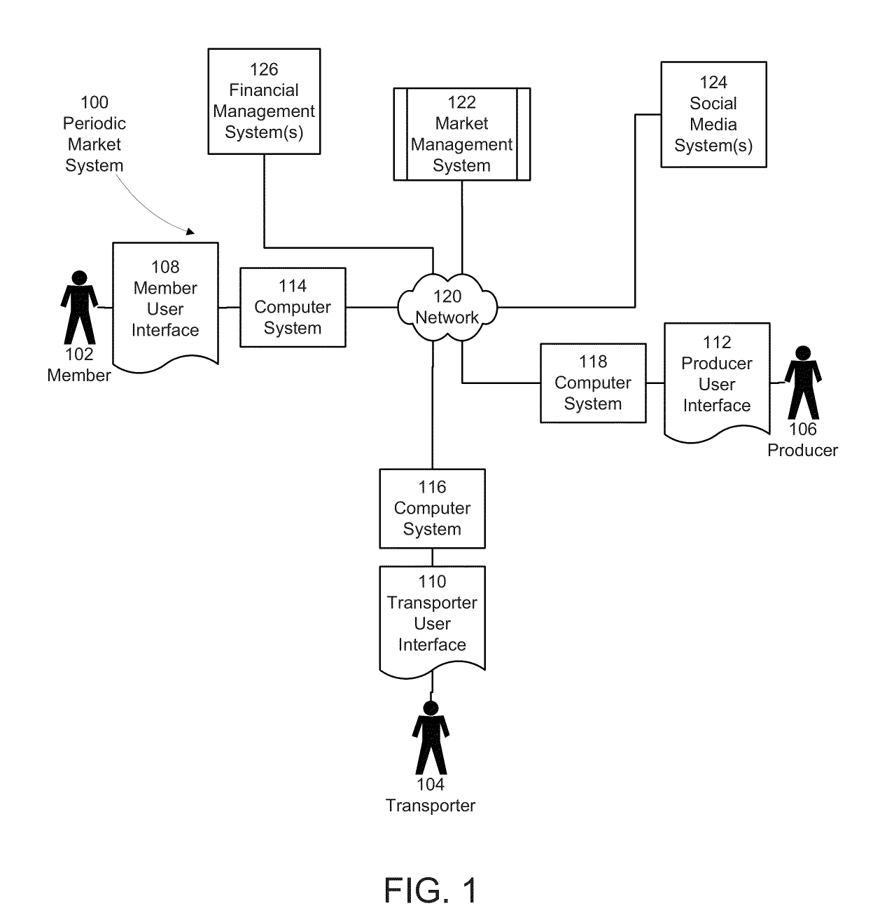

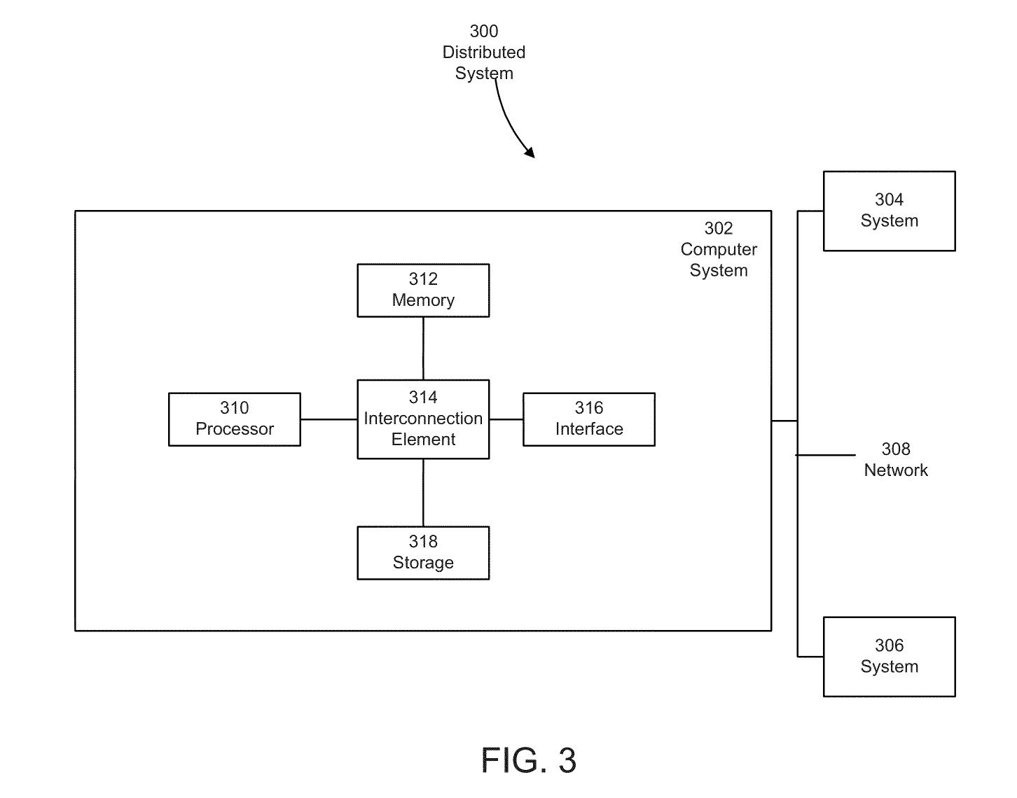

Some embodiments disclosed herein implement a periodic market system using one or more computer systems, such as the computer systems described below with reference to FIG. 3. According to these embodiments, a periodic market system organizes, establishes, monitors, and manages periodic market gatherings. FIG. 1 illustrates an example market management system 122 within the context of an example periodic market system 100. As shown in FIG. 1, the periodic market system 100 includes a member 102, a transporter 104, a producer 106, a member user interface 108, a transporter user interface 110, a producer user interface 112, computer systems 114, 116, and 118, a communications network 120, the market management system 122, social media systems 124, and financial system(s) 126. The member 102 may interact (e.g., provide or receive information) with the member user interface 108. The transporter 104 may interact with the transporter user interface 110. The producer 106 may interact with the producer user interface 112.

As depicted in FIG. 1, the computer systems 114, 116, and 118, the market management system 122, the social media systems 124, and the financial management systems 126 exchange (i.e. transmit or receive) information via the network 120. The network 120 may include any communication network through which computer systems exchange information. For example, the network 120 may be a public network, such as the Internet, and may include other public or private networks such as LANs, WANs, extranets, intranets, and cloud computing systems. Although shown as a single network in FIG. 1, in some embodiments, the network 120 includes a plurality of communication networks.

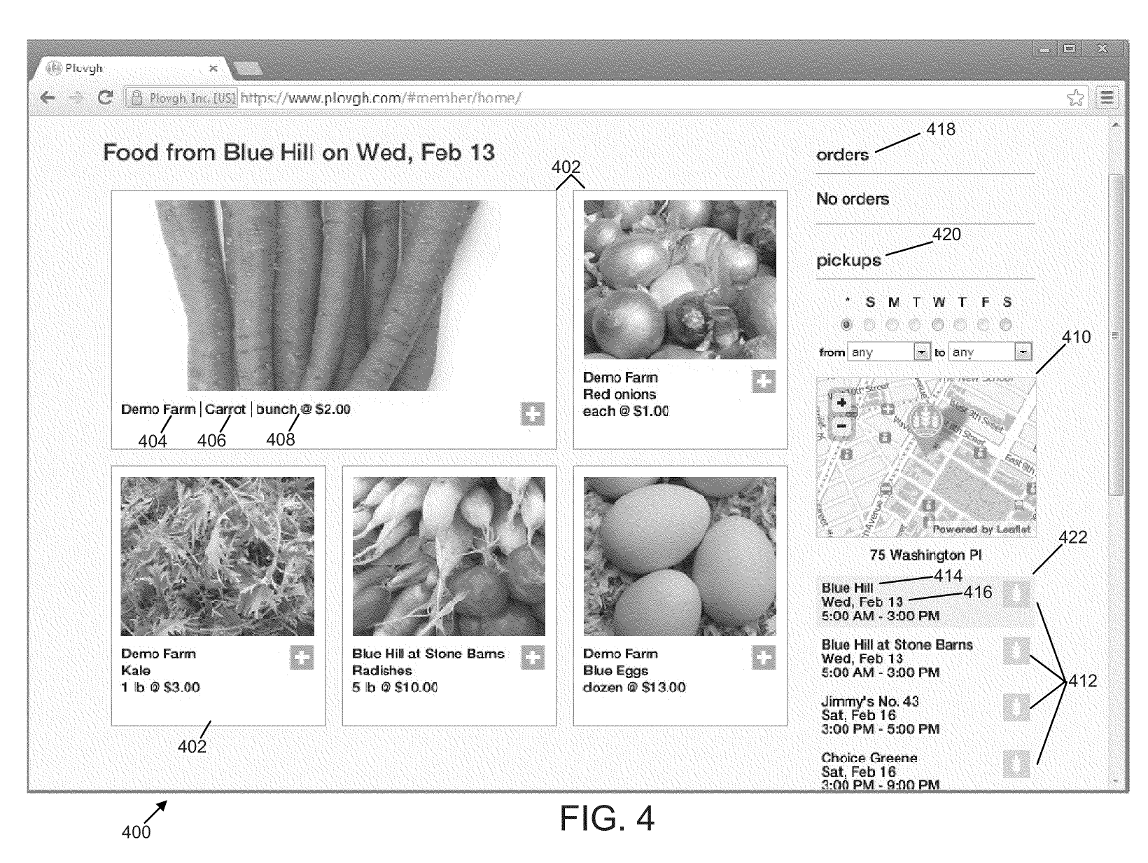

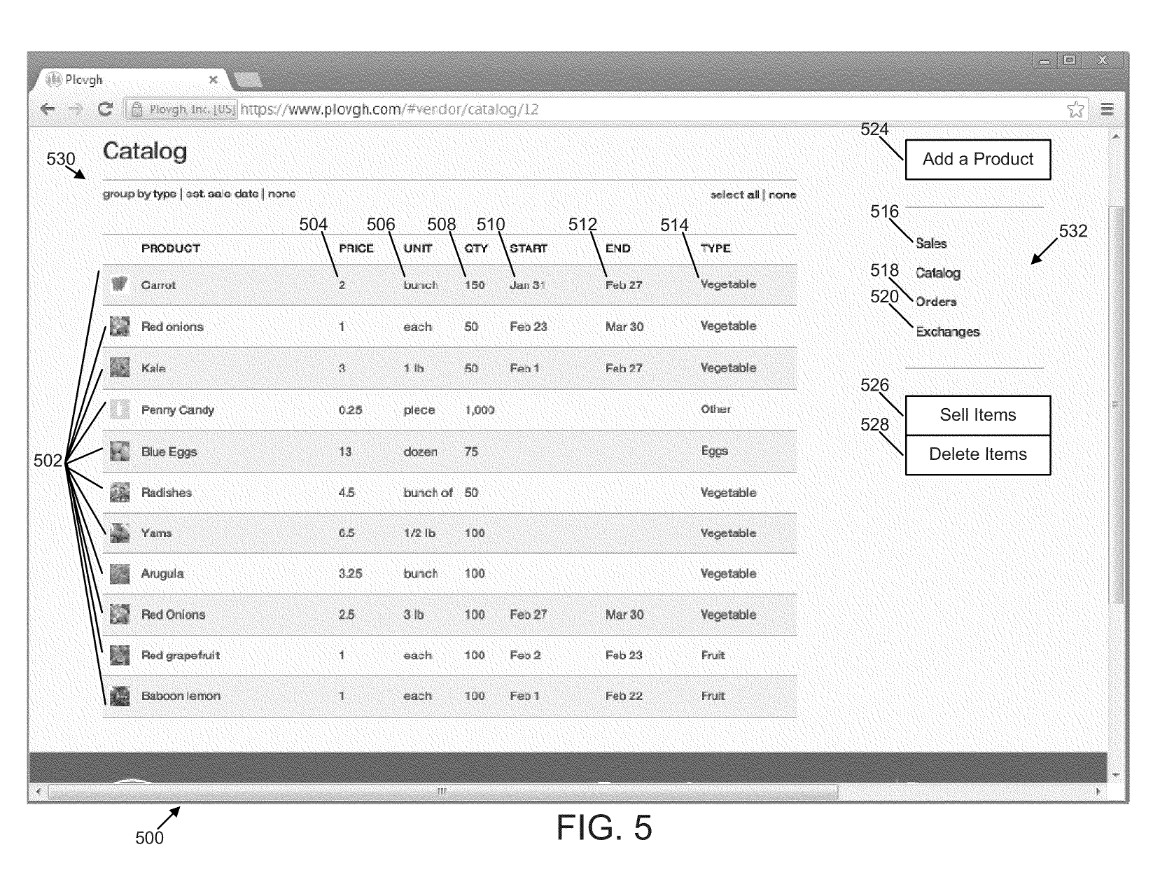

In the embodiment illustrated in FIG. 1, the market management system 122 is configured to implement the user interfaces 108, 110, and 112 in conjunction with the computer systems 114, 116, and 118 via the network 120. For example, in some embodiments illustrated by FIG. 1, the interfaces 108, 110, and 112 are browser-based user interfaces served by the market management system 122. In other embodiments, the user interfaces 108, 110, and 112 are implemented as components within social media systems, such as the FACEBOOK social networking system available online from Facebook Inc. of Menlo Park, Calif. In still other embodiments, the interfaces 108, 110, and 112 are specialized client programs that execute outside of a browser environment, such as an application program executing on a mobile device. The user interfaces 108, 110, and 112 may be implemented using a variety of technologies and may include sundry elements (e.g., screens, windows, buttons, boxes, etc) arranged according to various user interface metaphors. As described further below, FIG. 4 further illustrates some of the elements used to implement the member user interface 108, and FIG. 5 illustrates some of the element used to implement the producer interface 112.

In some embodiments, the market management system 122 exchanges information with the social media systems 124. Examples of the social media systems 124 include FACEBOOK, the TWITTER social networking and microblogging service available online from Twitter, Inc. of San Francisco, Calif., the FOURSQUARE location based social network system available online from Foursquare Labs, Inc. of New York, N.Y., the GOOGLE+ social networking system available online from Google Inc. of Mountain View, Calif., the LINKEDIN social networking system available online from Linkedin Corporation of Mountain View, Calif., mailing lists, email systems, texting systems, telephone systems, and the like. The information exchanged between the market management system 122 and the social media systems 124 may include data descriptive of identified users of the market management system 122, such as indications of the validity of logon credentials, account information, and profile information, as well as data descriptive of the social network to which the identified users belong, such as groups, friends, followers, other users commented on by the identified users, or other users who authored comments associated with the identified users. The information exchanged between the market management system 122 and the social media systems 124 may further include activity conducted by users of the market management system 122, such as entering products available for sale, ordering products, receiving delivery of ordered products, and the like.

In other embodiments, the market management system 122 exchanges information with the financial management systems 126. These financial management systems 126 may include financial systems, payment networks, and issuing banks. Examples of the financial systems include the PAYPAL system available online from PayPal, Inc. of San Jose, Calif., the YODLEE system available from Yodlee, Inc. of Redwood City, Calif., the DWOLLA system available from Dwolla Inc. of Des Moines, Iowa and the like. Examples of payment networks 126 include VISANET available from Visa, Inc. of San Francisco Calif., BANKNET available from MasterCard International Incorporated of Purchase, New York, and the like. Examples of issuing banks include Citibank N.A. of New York, N.Y., Capital One Financial Corporation of Richmond, Va., JPMorgan Chase & Co. of New York, N.Y., Bank of America Corporation of Charlotte, N.C., and the like. Example financial systems also include escrow and payment processor services available from Balanced of Palo Alto, Calif. The information exchanged between the market management system 122 and the financial management systems 126 may include data descriptive methods of payment utilized by identified users, data descriptive of transactions conducted by the identified users, and data descriptive of markets redeemed by the identified users. In some embodiments, the market management system 122 detects transactions conducted using identified methods of payment and effects redemptions of markets by exchanging information with the financial management systems 126.

Information may flow between the components illustrated in FIG. 1, or any of the elements, components and subsystems disclosed herein, using a variety of techniques. Such techniques include, for example, passing the information over a network using standard protocols, such as TCP/IP, HTTP, or HTTPS, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

### Market Management System

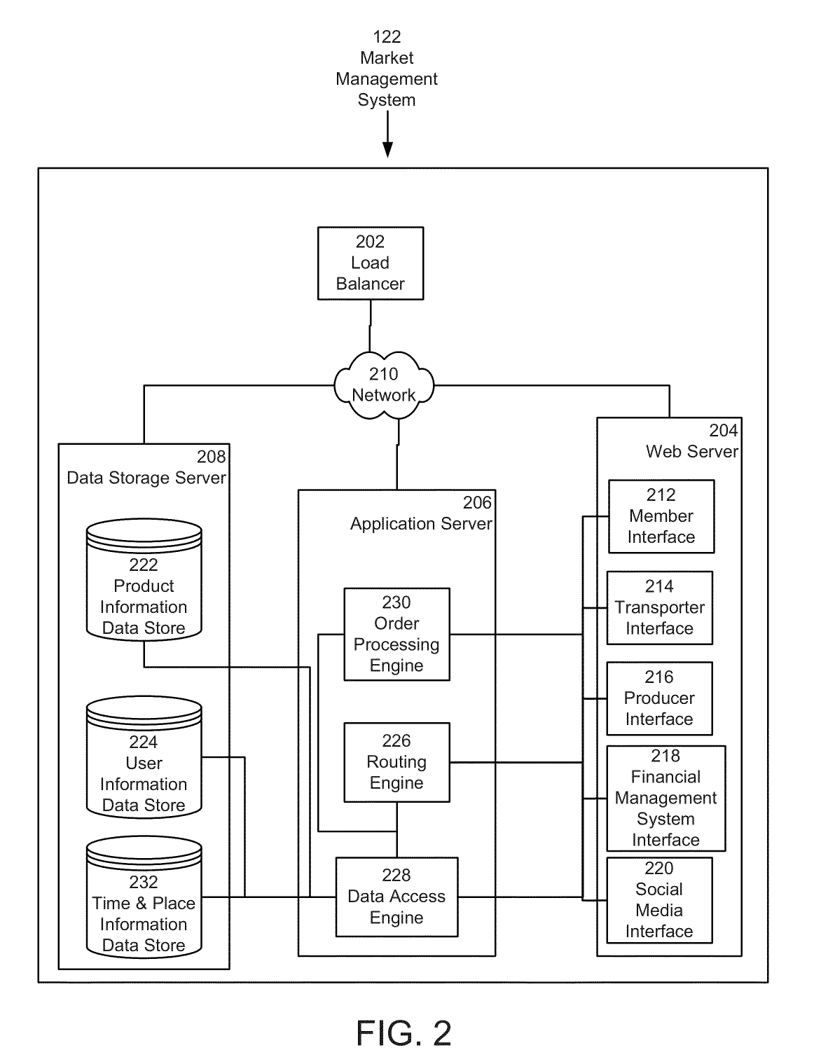

The market management system 122 may be configured according to a variety of architectures. FIG. 2 illustrates one such architecture in which the physical and logical components of the market management system 122 are configured as a distributed system. The architecture illustrated in FIG. 2 is provided for example purposes only and embodiments disclosed herein are not limited to the architecture shown in FIG. 2. For example, in some of the embodiments, the physical components described below may be virtualized.

As depicted in FIG. 2, the market management system 122 includes five primary physical elements: a load balancer 202, a web server 204, an application server 206, a data storage server 208 and a network 210. Each of these physical elements may include one or more computer systems as discussed below with reference to FIG. 3. The load balancer 202 provides load balancing services to the other components of market management system 122. The web server 204 may serve content using any suitable standard or protocol including, among others, HTTP, HTML, DHTML, XML, JSON and PHP. The data storage server 208 may provide data storage and retrieval services by using a database management system, such as MYSQL, POSTGRESQL, or ORACLE, or by using some other data storage methodology, such as a file system supported by the operating system executing on the data storage server 208. Like the network 120 described above with reference to FIG. 1, the network 210 may include any communication network through which member computer systems may exchange data.

In the embodiment illustrated in FIG. 2, the web server 204 includes five logical elements, a member interface 212, a transporter interface 214, a producer interface 216, a financial systems interface 218, and a social media interface 220. The application server 206 includes three logical elements: a routing engine 226, a data access engine 228, and an order processing engine 230. The data storage server 208 includes three logical elements: a product information data store 222, a user information data store 224, and a time and place information data store 232.

In the embodiment illustrated in FIG. 2, the web server 204 implements the member interface 212, the transporter interface 214, and the producer interface 216. Each of these interfaces may exchange information with a variety of external entities, such as users or external systems. For example, according to one embodiment, the member interface 212 is configured to serve a browser-based user interface to the member 102 that is rendered as the member user interface 108 by a web browser executing on the computer system 114. The transporter interface 214 and the producer interface 216 may also be configured to serve browser-based user interfaces to the transporter 104 and the producer 106 that are rendered as the transporter user interface 110 and the producer user interface 112 by web browsers executing on the computer systems 116 and 118.

According to some embodiments, the member interface 212 is configured to exchange information (e.g., name, address, addresses where the member can receive direct shipments, destinations preferred by the member, methods of payment utilized by a member, etc.) descriptive of a profile of a member, such as the member 102 described above with reference to FIG. 1. Information descriptive of the methods of payment included in the profile information may include information descriptive of a debit card account or a credit card account, checking account, etc. In at least one embodiment, the information descriptive of the methods of payment also specifies a default method of payment preferred by the member.

In some embodiments, the member interface 212 exchanges the profile information with the member user interface 108. In response to receiving the profile information, the member interface 212 stores, via the data access engine 228, the profile information in the user information data store 224.

According to one embodiment, the member interface 212 is configured to provide information descriptive of products available for purchase by a member, such as the member 102 described above with reference to FIG. 1, within the market management system 122. In this embodiment, the member interface 212 exchanges product information with the member user interface 108. The product information exchanged between the member interface 212 and the member user interface 108 may include product search requests and product search responses. Product search requests specify the characteristics of products targeted by the request. Product search responses may include information descriptive of products having the characteristics specified in a product search request corresponding to the product search response. Responsive to receiving a product search request, the member interface 212 may retrieve, via the data access engine 228, information descriptive of the products having the characteristics specified in the search criteria and may provide this information to the member user interface 108 for further processing. In at least one embodiment, the products available for purchase within the market management system 122 are defined by producers, such as the producer 106, who use the market management system 122.

It is to be appreciated that, in some embodiments, the product search responses for a member may contain products that may not be directly accessible via the destinations the member has identified as preferred but may be included in product search responses due to inclusion of other parameters with the corresponding product search request. Those product search responses may indicate that the product is not available from their preferred destinations, but can give the option to purchase the product through an alternative destination.

According to one embodiment, the member interface 212 is configured to provide information descriptive of producers, such as the producer 106 described above with reference to FIG. 1, in which the member is interested. In this embodiment, the member interface 212 exchanges producer information with the member user interface 108. The producer information exchanged between the member interface 212 and the member user interface 108 may include producer search requests and producer search responses. Producer search requests specify the characteristics of producers targeted by the request. Producer search responses may include information descriptive of producers having the characteristics specified in a producer search request corresponding to the producer search response. Responsive to receiving a producer search request, the member interface 212 may retrieve, via the data access engine 228, information descriptive of the producers having the characteristics specified in the search criteria and may provide this information to the member user interface 108 for further processing. In at least one embodiment, the producers available for review within the market management system 122 are the producers who use the market management system 122.

According to one embodiment, the member interface 212 is configured to provide information descriptive of destinations in which the member is interested. In this embodiment, the member interface 212 exchanges destination information with the member user interface 108. The destination information exchanged between the member interface 212 and the member user interface 108 may include destination search requests and destination search responses. Destination search requests specify the characteristics of destinations targeted by the request. Destination search responses may include information descriptive of destinations having the characteristics specified in a destination search request corresponding to the destination search response. Responsive to receiving a destination search request, the member interface 212 may retrieve, via the data access engine 228, information descriptive of the destinations having the characteristics specified in the search criteria and may provide this information to the member user interface 108 for further processing. In at least one embodiment, the destinations available for review within the market management system 122 are the destinations defined by routes within the market management system 122.

According to another embodiment, the member interface 212 is configured to provide information descriptive of destinations and drop-offs at which the member may receive ordered products. In this embodiment, the member interface 212 exchanges destination and drop-off information with the member user interface 108. The destination and drop-off information exchanged between the member interface 212 and the member user interface 108 may include destination and drop-off search requests and destination and drop-off search responses. Destination and drop-off search requests specify the characteristics of destinations and drop-offs targeted by the request. Destination and drop-off search responses may include information descriptive of destinations and drop-offs having the characteristics specified in a destination and drop-off search request corresponding to the destination and drop-off search response. Responsive to receiving a destination and drop-off search request, the member interface 212 may retrieve, via the data access engine 228, information descriptive of the destinations and drop-offs having the characteristics specified in the search criteria and may provide this information to the member user interface 108 for further processing.

For example, in one embodiment, the member interface 108 is configured to receive and process a destination and drop-off search request including an address, such as a home address of the member or an approximate or actual address of a destination or drop-off. In response to receiving such a request, the member interface 108 transmits a destination and drop-off request including information descriptive of the address to the member interface 212. In response to receiving the destination and drop-off request, the member interface 212 provides information descriptive of destination and drop-off locations that are within a default or requested radius of the address. In some embodiments, the member interface 108 provides a map displaying destination and drop-off locations. The member interface 108 may be centered the map on the address. The member interface 108 may also alter the representation of the map in response to member requests to zoom in or out or to reposition the map to different locations. The member interface 108 may also update the map to display destination and drop-off locations in the area shown by the map.

In some embodiments, the member interface 212 is configured to provide information descriptive of the products that are available for purchase according to destination and drop-off location. For example, the member interface 212 may receive an indication from the member interface 108 that the user has selected a particular destination or drop-off location. In response to receiving the indication, the member interface 212 provides information descriptive of products available for purchase at the selected destination or drop-off location. In some embodiments, the member interface 212 provides information descriptive of products available for purchase at multiple destination and drop-off locations in response to an indication, received from the member interface 108, that the member has selected multiple destination or drop-off locations.

According to another embodiment, the member interface 212 is configured to receive and process, by exchanging information with the order processing engine 230, one or more requests to order products from the member user interface 108. In this embodiment, the order requests may include information descriptive of a variety of product and destination or drop-off characteristics. Examples of these characteristics include a quantity of the product, a requested producer, and a requested destination or drop-off location. One example of a screen presented within the member user interface 108 and that is configured to generate an order request is described further below with reference to FIG. 4. Examples of processes executed by the member interface 108, the member interface 212, and the order processing engine 230 are described further below.

In some embodiments, responsive to the member user interface 108 requesting that a new order item be created, the member interface 212 transmits a request to the order processing engine 230 to create the new order item and record an order state of “requested” for the new order item. Responsive to receipt of this request, the order processing engine 230 creates a new order item with an order state of “requested” via the data access engine 228. Requested order items may not count towards the depleted quantity of the sale item until the member confirms the requested order items via the member user interface 108. In some embodiments, once an order item is reserved and payment is successfully transacted (e.g., via a credit card account), the quantity available of a sale item that the order item represents is decremented. In some embodiments, the member interface 212 can add and remove order items from an order while the items are in requested state, with no repercussions to sale item quantities or moneys transferred.

In some embodiments, the order processing engine 230 removes order items that are not reserved (still in requested state) after a fixed amount of time (10 minutes, or as configured) or at the sale's confirmation date, whichever comes first.

In some embodiments, the member interface 212 is configured to provide information descriptive of products in which the member is interested but has not ordered. In these embodiments, the member interface 212 exchanges product information with the member user interface 108. The product information exchanged between the member interface 212 and the member user interface 108 may include product watch requests and product watch responses. Product watch requests specify the characteristics of products targeted by the request. Product watch responses may include information descriptive of products having the characteristics specified in a product watch request corresponding to the product watch response. Responsive to receiving a product watch request, the member interface 212 may store, via the data access engine 228, information descriptive of watch request criteria. When changes are made to any watched product, the order processing engine 230 will provide an update to member interface 212 for further processing. In some embodiments, any product may be subject to watch regardless of whether the product is in the catalog or in sale. In at least one embodiment, the products available for watch within the market management system 122 are defined by producers, such as the producer 106, who use the market management system 122.

According to some embodiments, the transporter interface 214 is configured to exchange information (e.g., name, address, methods of payment utilized by a transporter, etc.) descriptive of a profile of a transporter, such as the transporter 104 described above with reference to FIG. 1. Information descriptive of the methods of payment included in the profile information may include information descriptive of a debit card account or a credit card account, checking account, etc. In at least one embodiment, the information descriptive of the methods of payment also specifies a default method of payment preferred by the transporter.

In some embodiments, the transporter interface 214 exchanges the profile information with the transporter user interface 110. In response to receiving the profile information, the transporter interface 214 stores, via the data access engine 228, the profile information in the user information data store 224.

According to some embodiments, the transporter interface 214 provides information descriptive of routes and delivery logistics to the transporter via the transporter interface 110. This route and delivery information may include a list of products the transporter is to pick up and drop off by exchange, a list of exchanges from which the transporter is to pick up the products, and a list of destinations to which the transporter is to deliver the products. The route and delivery information can also include route information (e.g., estimated efficient routes connecting exchanges and destinations) and timing information (e.g., estimated and/or expected times of pick up at exchanges and delivery at destinations). The route and delivery information may be itemized, for example, according to destinations and characteristics of each destination. The route and delivery information may also be provided to the transporter via any communication interface, such as email, text message, and another medium.

According to some embodiments, the producer interface 216 is configured to exchange information (e.g., name, address, methods of payment utilized by a producer, etc.) descriptive of a profile of a producer, such as the producer 106 described above with reference to FIG. 1. Information descriptive of the methods of payment included in the profile information may include information descriptive of a debit card account or a credit card account, checking account, etc. In at least one embodiment, the information descriptive of the methods of payment also specifies a default method of payment preferred by the producer.

In some embodiments, the producer interface 216 exchanges the profile information with the producer user interface 112. In response to receiving the profile information, the producer interface 216 stores, via the data access engine 228, the profile information in the user information data store 224.

According to one embodiment, the producer interface 216 is configured to receive and process information descriptive of products made available for purchase by a producer, such as the producer 106 described above with reference to FIG. 1. In this embodiment, the producer interface 216 exchanges product information with the producer user interface 108. The product information exchanged between the producer interface 216 and the producer user interface 108 may include product entry requests. Product entry requests specify the characteristics of products that the producer plans on making available for sale in the future. For example, a farmer may decide what crops the farmer wants to plant and harvest. The farmer may enter product entry requests, which correspond to the crops, via the producer user interface 112. The product entry requests may indicate the crops, as well as anticipated quantities and harvest times of the crops.

Responsive to receiving a product entry request, the producer interface 216 maintains (e.g., inserts, updates, or deletes), via the data access engine 228, information descriptive of the products in a product catalog stored in the product information data store 222. Responsive to successfully maintaining the information descriptive of the products, the producer interface 216 transmits an acknowledgement that products specified in the corresponding product entry request were successfully processed by the producer interface 216 and the data access engine 228.

In one embodiment, the producer interface 112 is configured to receive and process an exchange search request including an address, such as a home address of the producer or an approximate or actual address of an exchange location. In response to receiving such a request, the producer interface 112 transmits an exchange location request including information descriptive of the address to the producer interface 216. In response to receiving the exchange request, the producer interface 216 provides information descriptive of exchange locations that are within a default or requested radius of the address. In some embodiments, the producer interface 112 provides a map displaying exchange locations. The producer interface 112 may be centered the map on the address. The producer interface 112 may also alter the representation of the map in response to producer requests to zoom in or out or to reposition the map to different locations. The producer interface 112 may also update the map to display exchange locations in the area shown by the map.

In some embodiments, the producer interface 216 is configured to receive and process requests for new exchange locations. In these embodiments, the producer interface 216 exchanges exchange request information with the producer user interface 108. The exchange information exchanged between the producer interface 216 and the producer user interface 108 may include exchange entry requests. Exchange entry requests specify the characteristics of a proposed exchange that the producer requests for future use. In some embodiments, the exchange includes one or more producers, one or more routes, and one or more times of exchange. In some embodiments, the exchange also includes a geographical location. In some embodiments, the location of the exchange is a location for producers to gather and provide products. In some embodiments, the location is a more general region where a transporter can receive products from producers, such as each of the producer's farms. In some embodiments, the location is a dynamic attribute that can change depending on the products available and the producers providing the products for each exchange pick up.

Responsive to receiving an exchange entry request, the producer interface 216 maintains (e.g., inserts, updates, or deletes), via the data access engine 228, information descriptive of exchange requests in a list stored in the product information data store 222. Responsive to successfully maintaining the information descriptive of the exchange requests, the producer interface 216 transmits an acknowledgement that the exchange request was successfully processed by the producer interface 216 and the data access engine 228.

In some embodiments, the producer interface 216 is configured to also provide, via the producer user interface 112, information descriptive of destination locations associated with each of the exchange locations, thereby indicating a potential pool of customers associated with each of the exchange locations. In some embodiments, interfaces to receive exchange requests can be on a separate exchange manager interface. One example of a user interface elements presented within the producer user interface 112 is described further below with reference to FIG. 5.

According to one embodiment, the producer interface 216 is configured to provide information descriptive of orders associated with the producer. In this embodiment, the producer interface 216 receives requests for order information from the producer user interface 112. These requests may include search criteria that indicate the characteristics of orders targeted by the request. Responsive to receiving these requests, the producer interface 216 may retrieve, via the data access engine 228, information descriptive of orders that match the search criteria and may provide this information to the producer user interface 112 for further processing.

Continuing with the embodiment illustrated in FIG. 2, the web server 204 also implements the financial systems interface 218 and the social media interface 220. Both of these interfaces may exchange information with a variety of external entities, such as users or external systems. For example, according to one embodiment, the financial systems interface 218 is configured to exchange information with one or more external financial systems. The information exchanged via the financial systems interface 218 may be descriptive of financial transactions initiated the member 102 or redeemed by the producer 104. More particularly, in at least one embodiment, the information exchanged via the financial systems interface 218 may debit accounts held by the member 102, may credit accounts held by the producer 104, verify a method of payment entered by the member 102.

According to another embodiment, the social media interface 220 exchanges information with one or more social media websites using API calls specific to each social media website. The information exchanged via the social media interface 220 may include information descriptive of the user (e.g., validity of logon credentials) and information descriptive of the user's social network (e.g., other users associated with the user on each social media website). In at least one embodiment, the information exchanged includes information descriptive of activity conducted by users of the market management system 122, such as entering products available for sale, ordering products, receiving delivery of ordered products, and the like.

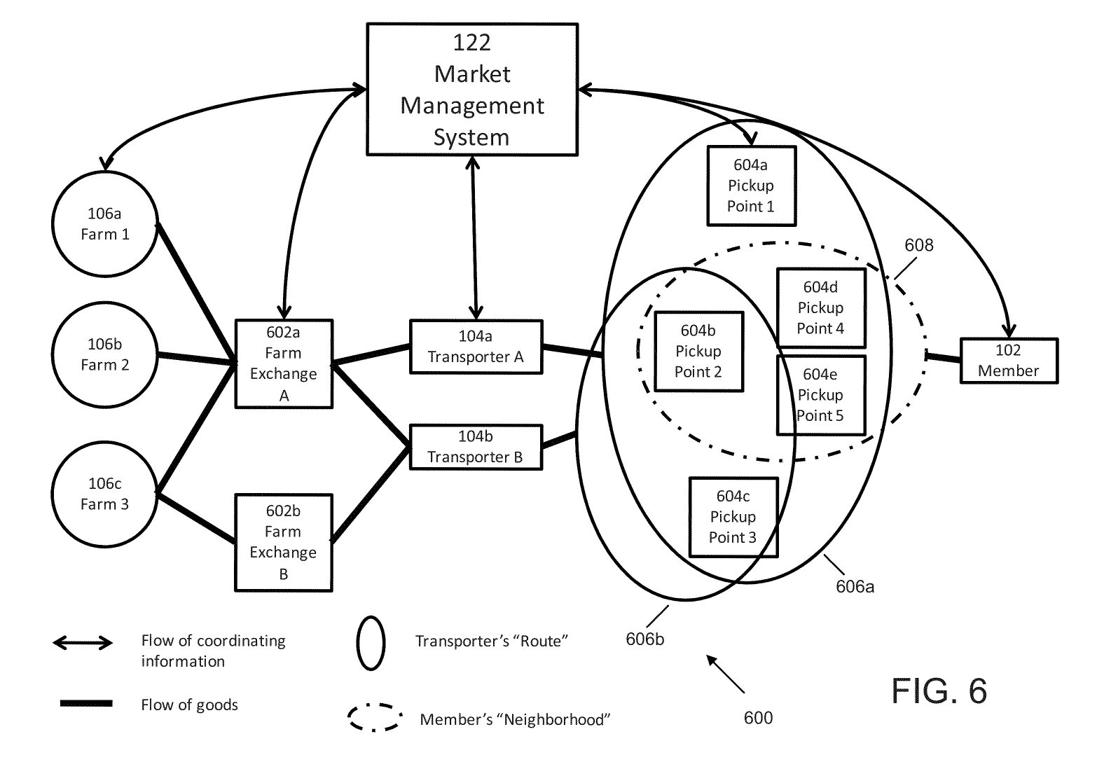

Referring again to FIG. 2, the application server 206 may provide computing resources to the routing engine 226, the data access engine 228, and the order processing engine 230. The routing engine 226 is configured to perform a variety of processes that facilitate the creation and modification of routes that are used by transporters to deliver products from producers to customers via exchanges and destinations. Example processes performed by the routing engine 226 are described further below with reference to FIG. 6. The order processing engine 230 is configured to perform various processes regarding order entry and fulfillment. Example processes performed by the order processing engine 230 are described further below with reference to FIG. 6.

In some embodiments, the processing engine 230 may place order items in a variety of states including the following list.

Requested—products have been added to the member order by the member and are temporarily placed in requested state. Order state transitions to an allocated state when pending confirmation (usually payment).
Allocated—pending payment transacted, the requested quantity is temporarily removed from the sale item's available quantity count. Member order items will be deallocated upon certain duration of inactivity or if the member cancels confirmation.
Reserved—after payment transacted successfully (failed transaction deallocates order items and returns available quantity count to sale item)
Unfilled—prior to sale's confirmation date, a producer may cancel currently reserved quantities of member order items, setting the state of those items to unfilled and triggering a refund process for members who reserved the products.
Confirmed—after sale's confirmation date, all reserved member order items are confirmed to have been received by the producer.
Canceled—after the sale's confirmation, a producer or the periodic market system may cancel currently confirmed quantities of member order items, setting the state of those items to canceled and triggering a refund process for affected members.
Exchanging—the product represented by the member order item is in the process of being packed by the producer and handed off to transporter(s) for distribution to the destination.
Staged—the product represented by the member order item is in a sort center or other location awaiting further distribution.
Delivered—the product represented by the member order item has reached the drop-off location, or has gone out for home delivery, or otherwise made it to a final location for the members to receive.
Expired—not a mutually exclusive state, member order items become expired by the system after a pre-configured period of time after reaching a final state (Unfilled, Canceled, Delivered).

It is to be appreciated that, according to some embodiments, the order processing engine 230 executes an ordering process that is not a traditional e-commerce “shopping cart,” but rather a fluid snapshot of a member's activity. Order items are added when requested, purchased when reserved, then the order states are modified as the order processing engine 230 performs subsequent order transactions, falling off of the main member order view provided by the member interface 212 as configured by the member. Some embodiments may implement features that provide components that enable premium members to schedule, automate, or define order states, catalog items and/or sale item statuses.

The data access engine 228 provides an application program interface (“API”) through which other components, such as the member interface 212, the transporter interface 214, the producer interface 216, the financial systems interface 218, the social media interface 220, the routing engine 226, and the order processing engine 230 exchange information with the product information data store 222, the user information data store 224, and the time and place information data store 232. In the embodiment shown in FIG. 2, the routing engine 226, the order processing engine 230, and the data access engine 228 exchange information with the member interface 212, the transporter interface 214, the producer interface 216, the financial systems interface 218, the social media interface 220, the product information data store 222, the user information data store 224, and the time and place information data store 232.

In the embodiment illustrated in FIG. 2, the data storage server 208 provides computing resources to the product information data store 222, the user information data store 224, and the time and place information data store 232. The product information data store 222 stores a variety of information related to products, orders, exchanges, destination, drop-offs and other non-user entities represented in the market management system 122. Examples of this information include characteristics of the non-user entities recited above and historical information descriptive of these non-user entities. The user information data store 224 stores information descriptive of the members, transporters, and producers who use the market management system 122. Examples of the information stored in the user information data store 224 include logon credentials and profile information. The time and place information data store 232 stores information descriptive of geographic locations, dates, days of the week, and times of day associated with producers, exchanges, destinations, transporters, members, orders, and other entities represented in the market management system 122. Examples of the information stored in the time and location data store include times and locations for product pick up at a destination. The data stores 222, 224, and 232 may take the form of any logical construction capable of storing information on a computer readable medium including flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

Various embodiments may implement the components described above using a variety of hardware components, software components and combinations of hardware and software components. Thus embodiments disclosed herein are not limited to the particular configuration illustrated in FIGS. 1 and 2 and may utilize alternative or additional components configured to perform the processes and functions described herein.

### Computer System

As discussed above with regard to FIGS. 1 and 2, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions and processes disclosed herein, the processor 310 performs a series of instructions that result in manipulated data. The processor 310 may be any type of processor, multiprocessor or controller. Some example processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 310 is connected to other system components, including one or more memory devices 312, by the interconnection element 314.

The memory 312 stores programs and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the interconnection element 314. The interconnection element 314 may include one or more physical busses, for example, busses between components that are integrated within a same machine, but may include any communication coupling between system elements including specialized or standard computing bus technologies such as IDE, SCSI, PCI and InfiniBand. The interconnection element 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### User Interface Screens

FIGS. 4 and 5 illustrate example interface screens provided according to various embodiments. It is to be appreciated that other interface screens may be provided, and embodiments described herein are not limited to a particular interface screen or set of screens. FIG. 4 illustrates a member screen 400 provided by a member interface, such as the member interface 212 describe above with reference to FIG. 2, via a member user interface, such as the member user interface 108 described above with reference to FIG. 1. As shown in FIG. 4, the member screen 400 includes a product display sections 402, a map 410, order display section 418, pickup display section 420, and destination display section 422. In one embodiment, the pickup display section 420 presents information descriptive of pickups that are scheduled by the member for orders that have been placed previously.

In some embodiments, as shown in FIG. 4, the product display sections 402 present information descriptive of products available for purchase to a member, such as the member 102 described with reference to FIG. 1. In the embodiment shown in FIG. 4, the information descriptive of the products includes a producer 404 of the product, a name 406 of the product, and a price per quantity 408 of the product.

Also as shown in FIG. 4, each of the products display sections 402 is configured to present images and descriptions of the product depicted within it. In some embodiments, each of the product display sections 402 is configured to provide more information about the product represented therein responsive to receiving an indication that the member has interest the presented image. For example, each of product display sections 402 may display additional information regarding its associated product responsive to the member hovering over or clicking on the image of the product.

As illustrated in FIG. 4, the map 410 shows destination locations where the member can receive products. A destination display section 422 including a listing of destinations 412 is provided below the map. The information displayed for each destination 412 in the listing includes a location 414 and a pickup date and time 416.

In at least one embodiment, the member screen 400 is configured to detect a selection of one or more destinations 412 by the member. For instance, the member screen 400 may detect a click on one or more destinations 412 or may detect a click on an icon displayed in the map 410 corresponding to one or more destinations 412. In some embodiments, the member screen 400 is configured to, responsive to detecting a selection of one or more destinations, generate and transmit a product search request to the member interface 212 including an identifier of the one or more selected destinations. Responsive to receiving a product search response, the member screen 400 updates the product display sections 402 with the product information included in the response. In this way, the member screen 400 shows products available at the one or more selection destinations 412.

In some embodiments, the member screen 400 is configured to display product information based on one or more addresses where the member viewing the screen can receive direct shipments. In these embodiments, the member screen 400 generates and transmits a product search request to the member interface 212 that includes an identifier of the member viewing the member screen 400. Responsive to receiving a product search response, the member screen 400 updates the product display sections 402 with the product information included in the response. This product information includes products recorded as directly shippable to addresses recorded with the member's profile information as being addresses where the member can receive direct shipments. In this way, the member screen 400 shows products that are directly shippable to the member.

In some embodiments, the order display section 418 includes a collection, such as a rolling list, of member order items that represents products that the member has purchased or reserved. A member order item includes a collection of information that is descriptive of a product that is on sale that a member intends to purchase. Stored characteristics of a member order item can include quantity, order status, member transaction information, and other data such as direct shipping tracking numbers, and other appropriate information. The order display section 418 may, by default, present the order items ordered by order state and delivery date. In some embodiments, the order display section 418 removes order items that are in a final order state 24 hours after the order transition occurred. In other embodiments, the order display section 418 can optionally display historical order items filtered according to a date filter.

FIG. 5 illustrates an example producer screen 500. The producer screen 500 is provided by a producer interface, such as the producer interface 216 describe above with reference to FIG. 2, via a producer user interface, such as the producer user interface 112 described above with reference to FIG. 1. As shown in FIG. 5, the producer screen 500 includes a catalog display section 530, a link selection section 532, a add product button 524, a sell items button 526, and a delete items button 528.

In some embodiments, the catalog display section 530 includes a list of products that a producer maintains. A catalog display section 530 may present one or more catalog items 502, which represent products that the producer can produce and that are either for sale or may be to for sale in the future.

Responsive to actuation of the add product button 524, the producer user interface 216 displays additional interface elements that receive information descriptive of the characteristics of the new product. The information descriptive of the characteristics may include an estimated date range a member can expect the product to be available in sale and whether the catalog item 502 is available to be shipped directly to an exchange, destination, or member that accepts direct deliveries. Responsive to receive of the information descriptive of the characteristics of the new product, the producer screen transmits a request to the producer interface 216 to create a catalog item entry for the new product.

Responsive to actuation of the sell items button 526, the producer user interface 216 provides additional interface elements that receive information descriptive of a request to place a catalog item on sale, thereby making the item a sale item, which is also referred to herein as being an “in sale” item. The information descriptive of the request to place the items on sale may include an identifier of the catalog item, a price 504, a unit 506 for the price 504, a quantity 508 available for sale, a start date 510, an end date 512, and a type 514. The start date 510 and an end date 512 may indicate a window of time that the producer expects to be able to harvest the product and provide the product to members who purchase the product.

In some embodiments, the information descriptive of the request to place the item on sale includes one or more exchanges selected by the producer via the additional interface elements provided by the producer user interface 216. In these embodiments, the selected exchanges defining how the product will be made available for discovery, purchase, and distribution. Any exchanges in which the producer is an exchange member and that have exchange meet times during that week will be presented for selection.

In some embodiments, the information descriptive of the request to place the item on sale includes a confirmation date, exchange date, and delivery date as defined for the associated exchange (which in turn has a defined confirmation day, an exchange day, and a delivery day). In these embodiments, the order processing engine 230 stores an indication, on the confirmation date, that the sale item is no longer available for sale. Sale items are expected to be transferred to the transporter(s) when the exchange date is reached. Sale items are expected to arrive at the appropriate destination location when the delivery date is reached. In some embodiments, the order processing engine 230 may update the status of sale items appropriately, in accord with these dates.

The link selection section 532 presents links to other user interface elements through which the producer can receive further information. For example, the link selection section 532 can include a sales link 516. Responsive to actuation of the sales link 516, the producer user interface 216 provides additional interface elements that provide information descriptive of currently active sale items. As described above, a sale item includes a representation of a catalog item that the producer has designated as being available for purchase, (e.g., that members are able to request and reserve the items as member order items). According to some embodiments, when defining the sale item, the producer user interface 112 prompts the producer to define the price, unit of purchase, quantity available, and whether the product can be shipped directly to an exchange, destination, or member that accepts direct deliveries (and direct shipping price, if applicable). The sale item keeps track of the quantities made available, those sold, and those remaining.

The link selection section 532 can also include a producer order link 518, which can show the producer current and/or pending orders for products made by members. Responsive to actuation of the order link 518, the producer user interface 216 provides additional interface elements that provide information descriptive of currently active orders and order items. In some embodiments, this information includes all of the order items that have been reserved by members for a sale item.

The link selection section 532 can also include an exchanges link 520, which can show exchanges to which the producer is delivering. Responsive to actuation of the exchanges link 520, the producer user interface 216 provides additional interface elements that provide information descriptive of currently active exchanges associated with the producer. This information may include additional exchanges to which the producer can deliver, as well as potential customers that can be reached by delivering to the additional exchanges. The producer can also add, modify, or remove exchanges via the producer user interface 216.

### Market Management Processes

As described above with reference to FIG. 2, some embodiments perform processes that manage products using a distributed system, such as the market management system 122. One example of such a market management process is illustrated in FIG. 6.

FIG. 6 shows an example process 600, including a flow of products from producers to members and a flow of information from the periodic market system 100 to each of the parties involved in the process 600.

In some embodiments, the process 600 implements a purchase and distribution model that uses two types of aggregation points: exchanges 602 and destinations 604. Exchanges 602 are locations at which producers 106 provide products and member orders are consolidated to be driven to destinations 604. Destinations 604 are locations from which member orders from exchanges 602 are combined and distributed to members 102. Exchanges 602 include groups of farms defined by a location, day, and time at which participating producers 106 provide pre-sold shipments to transporters 104, who will deliver each shipment to the appropriate destination 604. For example, destinations 604 could include locations such as existing market stands, restaurants, homes, offices, community centers, apartment complexes, sort centers, or other locations in neighborhoods where members 102 receive orders at a specified time.

A producer 106 produces one or more products that are sold through the periodic market system 100. Producers 106 belong to one or more exchanges 602, which allows the producer's product to be delivered to any destination 604 accessible on a route facilitated by transporters 104 to that exchange 602.

A member 102 purchases a producer's product. A member 102 see products made available to the member 102 via the order processing engine 230. The products available to the member 102 can be determined based on the destinations 604 the member 102 has selected and the exchanges 602 connected by routes to the selected destinations 604. In some embodiments, the periodic market system 100 receives one or more preferred destinations 604 from the member 102 indicating where the member 102 wants to receive purchased products. For example, a designated subset of destinations 604b, 604d, and 604e can be received as preferred destinations for receiving products.

In some embodiments, a member 102 belongs to a business and purchases products for the establishment represented by the business entity. In some embodiments, the destination may provide home delivery functionality that members 102 may opt in to.

Exchanges 602 include a designated time frame and general location when and where producers 106 convey products to a transporter 104. Exchanges 602 also include a route that connects the exchanges 602 to destinations 604 where members 102 receive the products as ordered. In some embodiments, exchanges 602 include one or more exchange managers, who create and maintain the exchange 602 and ensure the exchange 602 includes at least one associated producer 106, transporter 104, and route.

Transporters 104 serve as the connection between exchanges 602 and destinations 604. Transporters 104 include a truck or other means to deliver a product to a destination 604. In some embodiments, the routing engine 226 receives exchanges 602 and destinations 604 added or removed to routes by the transporter 104. Adding an exchange 602 to a route makes products from the producers associated with the exchange 602 available to the members 102 of the destinations 604 included on the route. The more destinations 604 a transporter 104 delivers to, the more members 102 the producers in the exchange 602 can reach. In some routing engine 226 dynamically modifies routes. For example, if no members from a certain destination placed any orders for a delivery cycle, the destination can be removed from the route for that delivery. Additionally, if destinations are added to the periodic market system 100 that are within a threshold distance from an existing route, the routing engine 226 can be modify the route to include the destination. The routing engine 226 can use such and other algorithms to modify and/or create routes for transporters 104. In some embodiments, each route is a set of exchanges 602 and destinations 604, including at least one of each, that are connected in a temporal and geographic order, and which has a manifestation that in some embodiments involves the transporter 104 moving products along the route from exchange 602 to destination 604.

In some embodiments, a destination 604 is a location where products are conveyed from a transporter 104. Destinations can include one or more types of specific locations, including but not limited to sorts and drop-offs. Sorts are destinations where orders are sorted before further distribution toward drop-offs, home delivery, or passed to other last-mile delivery methods. Drop-offs are destinations that are specific, addressable locations where order items can be received by members 102. Drop-offs can include pickups, where members 102 go to receive ordered items, or businesses, where a commercial entity receives ordered items. Destinations 604 can also include one or more destination managers who create and maintain the destinations 604. Destination managers ensure the destinations 604 can receive delivery from transporters 104 and that members 102 can retrieve orders.

An example process 600 can include an exchange of products. In some embodiments, an example model of flow of activity for a single product includes the order processing engine 230 receiving an added product as a catalog item from the producer, as described above. The catalog item can include photos and descriptions and other characteristics describing the product. The product is activated for sale at an exchange, creating a sale item containing confirmation, exchange, and delivery dates associated with the exchange. The product becomes available to purchase through the order processing engine 230 for each sale created by the producer, and thus through the exchange associated with each sale, and the destinations associated with each exchange.

The order processing engine 230 provides access to members to the products for purchase from producers that belong to the exchanges that are on routes that deliver to destinations specified by the members. The order processing engine 230 receives orders and payments from members. On the confirmation date (an attribute of the producer's sale via the sale's associated exchange), the order processing engine ends the availability of the product associated with the sale and aggregates orders into a bulk packing list that is communicated to the producer. The producer packs orders as instructed in the packing list and provides the shipment to a transporter associated with the exchange.

At the exchange, the shipment gets transferred to the transporter who takes the product to the destinations specified by the members. The transporter drives the shipment to destinations via a route that is specified by the routing engine 226 as a result of purchased products, reflecting actual demand. In some embodiments, shipments are combined and sorted before receipt by members. In some embodiments, products are delivered to drop-offs for immediate receipt by members. Members receive orders at the destination. The order processing engine 230 releases payments to the producer, the transporter, and any other service providers involved in the process 600.

The example process 600 also includes a flow of information. For example, the periodic market system 100 receives from a producer 106 information pertaining to a catalog and a harvest. As described above, the catalog includes a list of catalog items describing products that the farmer may provide for sale. Harvest information can include which of the catalog items are included in sales, and projected dates of availability for the catalog items. The periodic market system 100 provides to the producer 106 information including farm orders. Farm orders can include a set of member orders for products provided by the specific producer 106.

The periodic market system 100 receives from a farm exchange 602 via a farm exchange manager information pertaining to farm exchange setup and management. Farm exchange setup and management information can include the producers that belong to the farm exchange and the transporters and routes associated with the farm exchange. Accordingly, the farm exchange information can include destinations that can be reached from the farm exchange. In some embodiments, farm exchanges can be associated with multiple routes, providing an intersection point for multiple sets of producers and destinations. The period market system 100 provides to the farm exchange manger information including logistics for product exchange. The product exchange information can include a list of the products the farm exchange should receive from producers and to which transporters the products should be provided.

The periodic market system 100 receives from the transporter 104 information including farm exchange and route designation. In some embodiments, the transporter 104 decides which farm exchanges and destinations the transporter 104 wants to include on a route. In some embodiments, the routing engine 226 can provide suggested exchanges and destinations the transporter 104 can include on a route. In some embodiments, the routing engine 226 can suggest changes to routes, for example, based on product demand, capacity, and/or expected length of time for a route. The periodic market system 100 provides to the transporter 104 information including transport instructions. Transport instructions can include which products are to be picked up at which exchanges and dropped off at which destinations. Transport instructions can also include dates and times of expected pick up and drop off. Transport instructions can also include other information pertaining to the transport of goods, such as a preferred temperature of transport, a fragility of a product, and other such information.

The periodic market system 100 can receive information from destinations 604 via destination managers. The information provided by destination managers can include destination setup and management information. For example, the destination managers can provide information to the periodic market system 100 on an initial setup of the destination, such as an address and dates and times for receiving products and providing products to members. The information can also include capacity information, such as how much and how long space is available for product storage. The information can also include routes and transporters, and accordingly, exchanges and producers that are associated with the destinations. The period market system 100 provides to destination managers information including logistics for product exchange. The product exchange information can include a list of the products the destination should receive from transporters and to which members which products should be provided. The product exchange information can also include information pertaining to sorting and packaging of products for members.

The periodic market system receives from the member 102 information including a neighborhood, which can include a subset preferred destinations for the member 102 to receive products. The periodic market system also receives order information, including products requested for purchase from producers and payment information. The periodic market system 100 provides to the member 100 product information, for example, based on the neighborhood provided by the member 100. The periodic market system 100 also provides confirmation information for purchased products and information pertaining to availability of the purchased products at the designated destinations.

The example process 600 depicts one particular sequence of acts in a particular example. The acts included in these processes may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. Furthermore, as discussed above, in at least one example, the acts are performed on a particular, specially configured machine, namely an market management system configured according to the examples and embodiments disclosed herein.

While various roles, such as producers, transporters, exchange and destination managers and other roles have been described, such roles can overlap. For example, a producer can also be an exchange manager as well as a transporter. Destination managers can also be exchange managers and/or destination managers of multiple destinations. Other such appropriate combinations of roles can be implemented without altering the scope of the specification.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system comprising:
memory;
at least one processor coupled to the memory;
a producer interface component executed by the at least one processor and configured to receive information descriptive of at least one product produced by at least one producer associated with at least one exchange;
a member interface component executed by the at least one processor and configured to receive information descriptive of at least one order requested by at least one member to associated with at least one destination, the at least one order including at least one identifier of the at least one product; and
a routing engine component executed by the at least one processor and configured to identify at least one route including the at least one exchange and the at least one destination.

2. The system according to claim 1, wherein the information descriptive of the at least one product includes an indication of whether the at least one product is available for sale.

3. The system according to claim 2, wherein the indication includes one or more identifiers of one or more exchanges through which the at least one product is available for sale.

4. The system according to claim 3, wherein the indication includes information descriptive of a confirmation date on which the at least one product is no longer available for sale through the at least one exchange.

5. The system according to claim 4, wherein the indication includes information descriptive of one or more exchange dates on which the at least one product will be delivered based on the description and routes of one or more exchanges.

6. The system according to claim 5, wherein the indication includes information descriptive of one or more delivery dates on which the at least one product will be delivered to the one or more destinations.

7. The system according to claim 6, wherein the information descriptive of the at least one order includes:
at least one identifier of the at least one producer;
at least one identifier of the at least one destination;
at least one identifier of the at least one product; and
information descriptive of a method of payment.

8. The system according to claim 7, further comprising an order processing engine component executed by the at least one processor on the confirmation date and configured to:
store an indication that the at least one product is no longer available for sale;
aggregate one or more orders including:
the at least one identifier of the at least one product; and
the at least one identifier of the at least one producer; and
the at least one identifier of the at least one exchange; and
provide information descriptive of the one or more orders to the producer interface.

9. The system according to claim 8, further comprising a transporter interface component executed by the at least one processor and configured to:
receive information descriptive of the one or more orders, the information including:
a first quantity of the at least one product to be delivered to the at least one exchange on the exchange date; and
a second quantity of the at least one product to be delivered to the at least one destination; and
provide the information descriptive of the one or more orders to an external entity.

10. A method implemented by a computer system, the method comprising:
receiving, by the computer, information descriptive of at least one product produced by at least one producer associated with at least one exchange;
receiving, by the computer, information descriptive of at least one order requested by at least one member associated with at least one destination, the at least one order including at least one identifier of the at least one product; and
identifying, by the computer, at least one route including the at least one exchange and the at least one destination.

11. The method according to claim 10, wherein receiving the information descriptive of the at least one product includes receiving an indication of whether the at least one product is available for sale.

12. The method according to claim 11, wherein receiving the indication includes receiving one or more identifiers of one or more exchanges through which the at least one product is available for sale.

13. The method according to claim 12, wherein receiving the indication includes receiving information descriptive of a confirmation date on which the at least one product is no longer available for sale through the at least one exchange.

14. The method according to claim 13, wherein receiving the indication includes receiving information descriptive of one or more exchange dates on which the at least one product will be delivered based on the description and routes of one or more exchanges.

15. The method according to claim 14, wherein receiving the indication includes receiving information descriptive of one or more delivery dates on which the at least one product will be delivered to the one or more destinations.

16. The method according to claim 15, wherein receiving the information descriptive of the at least one order includes:
at least one identifier of the at least one producer;
at least one identifier of the at least one destination; and
information descriptive of a method of payment.

17. The method according to claim 16, further comprising:
storing, on the confirmation date, an indication that the at least one product is no longer available for sale;
aggregating, on the confirmation date, one or more orders including:
the at least one identifier of the at least one product; and
the at least one identifier of the at least one producer; and
the at least one identifier of the at least one exchange; and
providing, on the confirmation date, information descriptive of the one or more orders to the producer interface.

18. The method according to claim 17, further comprising:
receiving information descriptive of the one or more orders, the information including:
a first quantity of the at least one product to be delivered to the at least one exchange on the exchange date; and
a second quantity of the at least one product to be delivered to the at least one to destination; and
providing the information descriptive of the one or more orders to an external entity.

19. A non-transitory computer readable medium having stored thereon a set of computer executable instructions that instruct at least one processor to execute the method of claim 10.

20. A method of establishing a time and place based market, the method comprising:
identifying at least one exchange;
identifying at least one destination;
receiving information descriptive of a plurality of products produced by a plurality of producers who deliver to the at least one exchange at a predetermined time;
receiving information descriptive of a plurality of orders requested by a plurality of members who receive product at the at least one destination;
identifying at least one route including the at least one exchange, the at least one destination, and an exchange meet time equal to the predetermined time; and
scheduling transportation of the plurality of products from the at least one exchange to the at least one destination, the transportation including receiving of the plurality of products during the exchange meet time and delivery at the destination during delivery time.
